(19) United States
(12) Patent Application Publication
(10) Pub. No.: US 2026/0051842 A1
(43) Pub. Date: Feb. 19, 2026

(54) FASTENING ASSEMBLIES FOR SOLAR TRACKER SYSTEMS

(71) Applicant: Nextracker LLC, Fremont, CA (US)

(72) Inventors: Elizio Chaves, São Paulo (BR); Gustavo Henrique Ferreira Soares, Sorocaba - SP (BR); Paulo de Oliveira Weinhardt, Sorocaba - SP (BR)

(21) Appl. No.: 19/291,862

(22) Filed: Aug. 6, 2025

Related U.S. Application Data
(60) Provisional application No. 63/683,373, filed on Aug. 15, 2024.

(51) Int. Cl. H02S 20/32; F16B 7/04

(52) U.S. Cl. CPC H02S 20/32; F16B 7/04

(57) ABSTRACT

A coupling system for use with a solar tracker and a method of use are described herein. The coupling system includes a support rail having a torque tube receiving surface configured to interface with a torque tube. One or more rigid arms configured to couple the support rail to the torque tube, each rigid arm pivotably connected to the support rail and being pivotable about a rotational axis. The one or more rigid arms configured to extend at least partially around the torque tube and pivotable into a closed position. The one or more rigid arms having one or more distal ends fastenable to secure the one or more rigid arms in the closed position.

### RELATED APPLICATIONS

This application claims the benefit of U.S. Provisional Patent Application No. 63/683,373, filed Aug. 15, 2024, the entire contents of which are incorporated herein by reference.

### TECHNICAL FIELD

This disclosure relates generally to solar power generation systems, and more particularly, to fastening mechanisms for solar arrays within a solar tracking system.

### BACKGROUND

Solar cells and solar panels are most efficient in sunny conditions when oriented towards the sun at a certain angle. Many solar panel systems are designed in combination with solar trackers, which follow the sun's trajectory across the sky from east to west in order to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds to thousands of individual solar modules that are mechanically coupled to support structures.

Coupling the numerous solar modules to the support structure requires a significant number of clamps or other mechanisms, each requiring a significant number of fasteners, driving up the cost of manufacturing each mechanism. As can be appreciated, assembling each of these mechanisms and securely tightening each fastener requires an enormous amount of time, contributing to increased cost and longer assembly time.

In view of these costly processes and designs, fastening mechanisms that alleviate the need for costly and time-consuming processes, and reduce the amount of material and labor required for installation are needed.

### SUMMARY

In general, the present disclosure relates to support structures for solar arrays with solar tracking system. In a first example, a coupling system for use with a solar tracker may include a support rail defining opposed top and bottom surfaces, the top surface configured to support a portion of a solar module, the bottom surface defining a saddle shape that includes a torque tube receiving surface configured to interface with a torque tube. Two rigid arms may be configured to couple the support rail to the torque tube, each rigid arm pivotably connected to the support rail and being pivotable about a rotational axis, the two rigid arms pivotable into a closed position, each rigid arm having upper and lower portions with the respective rotational axis being therebetween, the lower portion extending from the bottom surface of the support rail and configured to extend at least partially around a torque tube, the upper portion extending towards the torque tube receiving surface. The pivotable connections may move the upper portions towards the torque tube receiving surface when the two rigid arms are pivoted towards the closed position, the upper portions configured to be pushed towards the torque tube receiving surface as when the two rigid arms are pivoted towards the closed position.

Additionally or alternatively, the torque tube receiving surface has one or more recesses for receiving the upper portions of the two rigid arms when the two rigid arms are pivoted to the closed position.

Additionally or alternatively, the upper portions and the one or more recesses cooperate such that the upper portions are flush with or recessed from the torque tube receiving surface when the two rigid arms are pivoted to the closed position.

Additionally or alternatively, the torque tube receiving surface engages the torque tube when the two rigid arms are pivoted to the closed position.

Additionally or alternatively, the upper portions are pushed into the one or more recesses by a torque tube when the torque tube receiving surface is moved towards the torque tube.

Additionally or alternatively, the two rigid arms may be pivoted towards the closed position when the torque tube receiving surface is moved towards the torque tube.

Additionally or alternatively, the lower portions may have distal ends, the two rigid arms and the pivotal connections cooperating such that the two rigid arms pivot to a neutral position under the force of gravity, the distal ends in the neutral position forming a gap therebetween wide enough to permit a portion of a torque tube to pass therethrough.

Additionally or alternatively, the gap formed when the two rigid arms are pivoted to the neutral position is sufficiently wide that the gap will widen when the torque tube receiving surface is moved towards the torque tube.

Additionally or alternatively, the two rigid arms are pivotable to an open position where the gap between the distal ends of the lower portions is wide enough to pass the entire torque tube therethrough, the gap width of the open position being wider than the gap width of the neutral position.

Additionally or alternatively, a bump extending from the torque tube receiving surface that is configured for insertion into a hole in the torque tube to restrict relative movement between the support rail and the torque tube, the bump being located between the upper portions of the rigid arms when the arms are pivoted to the closed position.

Additionally or alternatively, the lower portions have distal ends fastenable together via a connector, such as a bolt, screw clamp, or via connectors formed on the distal ends, when the two rigid arms are pivoted to the closed position, the two rigid arms resisting rotation of the torque tube relative to the two rigid arms via frictional engagement between the two rigid arms and the torque tube when the lower portions are fastened together.

Additionally or alternatively, the two rigid arms include one or more ribs to add rigidity or have a non-flat cross-section to add rigidity.

Additionally or alternatively, the pivotal connection between each of the two rigid arms and the support rail is via pin that extends therethrough providing pivoting about the central axis of the pin.

In another example, a coupling system for use with a solar tracker may include a support rail defining opposed top and bottom surfaces, the top surface configured to support a portion of a solar module, the bottom surface defining a saddle shape that includes a torque tube receiving surface configured to interface with a torque tube. One rigid arm configured to couple the support rail to the torque tube, the one rigid arm pivotably connected to the support rail and being pivotable about a rotational axis, the one rigid arm having a lower portion extending from a pivotal connection and from the bottom surface of the support rail and configured to extend around a torque tube, and the one rigid arm having a distal end fastenable to the support rail at a rail connection point via a connector, such as a bolt, screw clamp, or via connectors formed on the distal ends, when the one rigid arm is pivoted to a closed position, the one rigid arm and the pivotal connection cooperating such that the one rigid arm pivots to a neutral position under the force of gravity, the distal end in the neutral position forming a gap with the rail connection point wide enough to permit a portion of a torque tube to pass therethrough, the gap formed when the one rigid arm is pivoted to the neutral position is sufficiently wide that the gap will widen when the distal end and the rail connection point are moved towards the torque tube.

Additionally or alternatively, the one rigid arm is pivotable to an open position where the gap between the distal end and rail connection point is wide enough to pass the entire torque tube therethrough, the gap width of the open position being wider than the gap width of the neutral position.

In another example, a method of using a coupling system to couple a rail to a torque tube may include positioning a coupling system adjacent a torque tube. The coupling system may include a support rail defining opposed top and bottom surfaces, the top surface configured to support a portion of a solar module, the bottom surface defining a saddle shape that includes a torque tube receiving surface configured to interface with a torque tube, and one or more rigid arms configured to couple the support rail to the torque tube, the one or more rigid arms pivotably connected to the support rail and being pivotable about a rotational axis. When the one or more rigid arms are in a neutral position, a gap is formed that is sufficiently wide enough to permit a portion of the torque tube to pass therethrough. The method further includes moving the torque tube receiving surface towards the torque tube, thereby widening the gap to permit the entire torque tube to pass therethrough, and moving the one or more rigid arms to a closed position thereby creating a frictional engagement between the one or more rigid arms and the torque tube resist rotation of the torque tube relative to the one or more rigid arms.

Additionally or alternatively, the one or more rigid arms comprises two rigid arms configured to couple the support rail to the torque tube, each rigid arm pivotably connected to the support rail and being pivotable about a rotational axis, the two rigid arms pivotable into a closed position, each rigid arm having upper and lower portions with the respective rotational axis being therebetween, the lower portion extending from the bottom surface of the support rail and configured to extend at least partially around a torque tube, the upper portion extending towards the torque tube receiving surface.

Additionally or alternatively, the torque tube receiving surface has one or more recesses for receiving the upper portions of the two rigid arms when the two rigid arms are pivoted to the closed position, and the upper portions and the one or more recesses cooperate such that the upper portions are flush with or recessed from the torque tube receiving surface when the two rigid arms are pivoted to the closed position.

Additionally or alternatively, the one or more rigid arms comprises one rigid arm configured to couple the support rail to the torque tube, the one rigid arm pivotably connected to the support rail and being pivotable about a rotational axis, the one rigid the lower portion extending from pivotal connection and from the bottom surface of the support rail and configured to extend around a torque tube.

Additionally or alternatively, the one rigid arm is pivotable to an open position where the gap between a distal end and a rail connection point is wide enough to pass the entire torque tube therethrough, a gap width of the open position being wider than a gap width of the neutral position.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2A is a front view of a fastening assembly coupled to a torque tube in accordance with the present disclosure;

FIG. 2B is a bottom perspective view of the fastening assembly, as in FIG. 2A, with the torque tube removed;

FIG. 3A is a front view of the fastening assembly, as in FIG. 2A, in a slightly open position;

FIG. 3B is a bottom perspective view of the fastening assembly, as in FIG. 3A, with the torque tube removed;

FIG. 4 is a front view of the fastening assembly, as in FIG. 2A, in a fully open position, with the torque tube removed;

FIG. 5 is a bottom perspective view of a rail of the fastening assembly, as in FIG. 4, with arms removed;

FIGS. 6A to 6E illustrate a method of use for the fastening assembly, as in FIGS. 2A to 5;

FIG. 7A is a front view of a fastening assembly in accordance with the present disclosure;

FIG. 7B is a is a bottom perspective view of the fastening assembly as in FIG. 7A, with the torque tube removed;

FIG. 7C is a top perspective view of the fastening assembly as in FIG. 7A, with the torque tube removed;

FIG. 8 is a front view of the fastening assembly, as in FIG. 7A, with an arm in an open position and the torque tube removed; and

FIGS. 9A to 9D illustrate a method of use for the fastening assembly, as in FIGS. 7A to 8.

### DETAILED DESCRIPTION

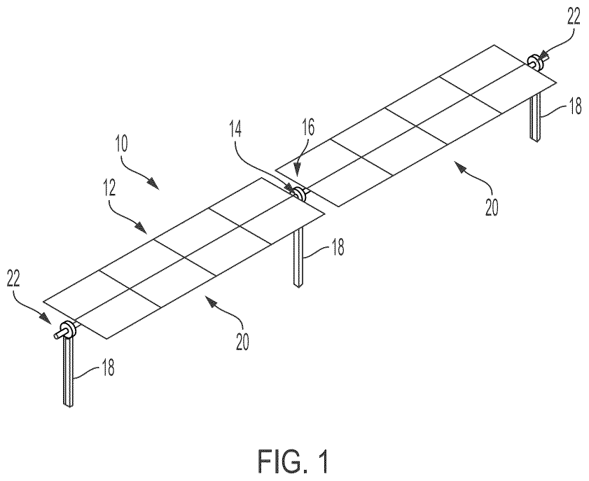

The present disclosure is directed to a toolless fastening assembly for a solar power system, generally referred to herein as a solar tracker. FIG. 1 is an elevation view of a common arrangement of a solar tracker 10 provided in accordance with the present disclosure. The solar tracker 10 may be formed of a plurality of bays 20 defined by the distance between ground piles 18 (generally referenced herein as piles 18). FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced and to absorb torsional loads applied to the torque tube 14 by wind loading. In addition, since there is often just a single drive mechanism 16, the specifications for the torque tube 14 may desire to eliminate twist of the torque tube 14 along its length. Twisting of the torque tube 14 would result in the solar modules 12 being oriented differently from what is desired, and thus again reduce the output and efficiency of the solar tracker 10, particularly, as the solar tracker 10 is rotated to the extreme angles of permitted range (e.g., +/−60 degrees or more).

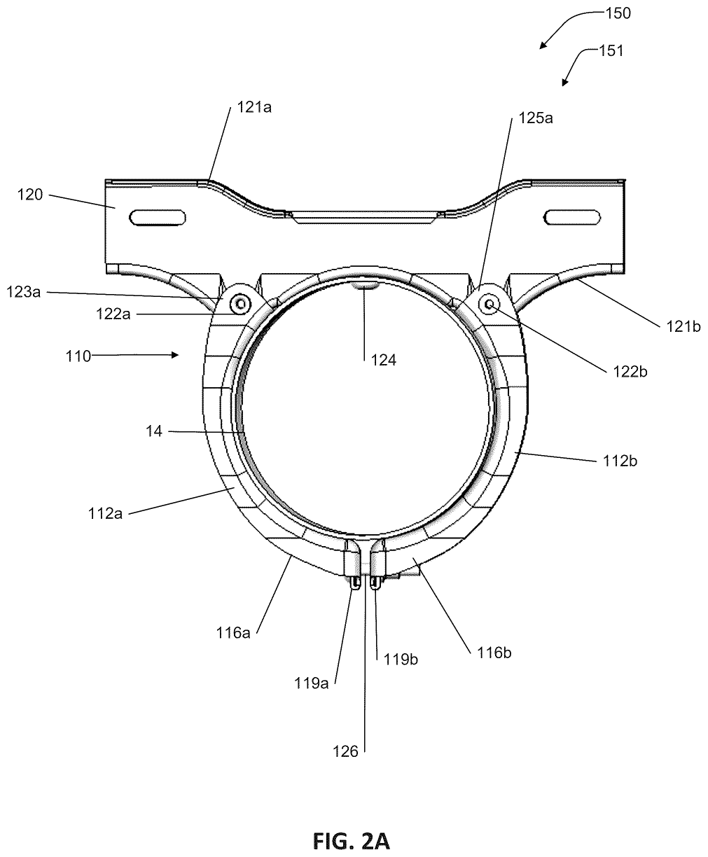

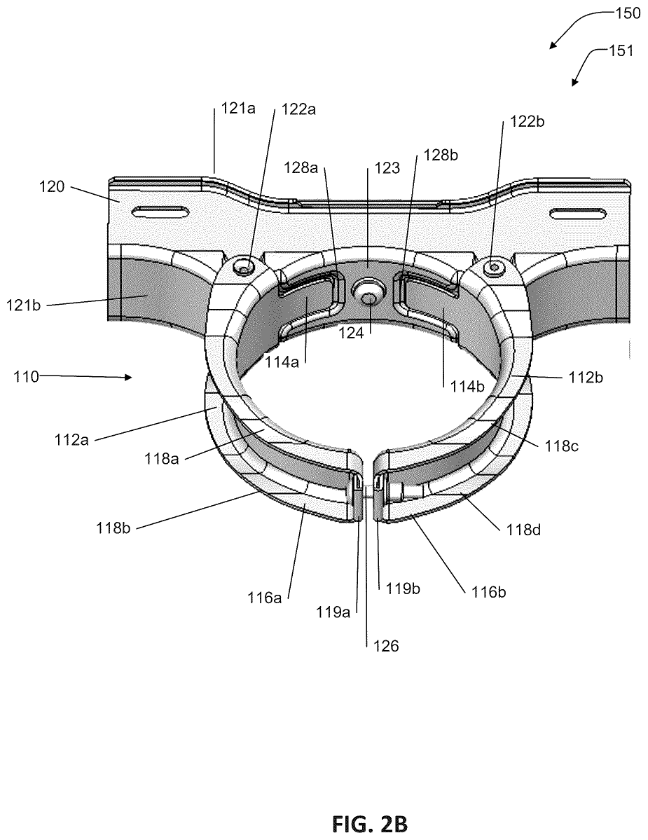

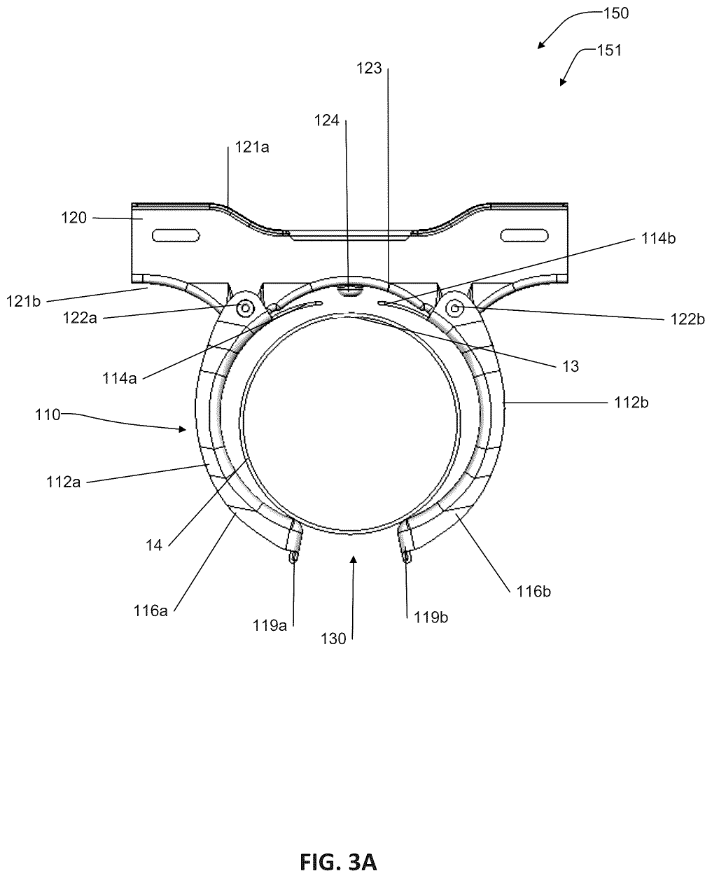

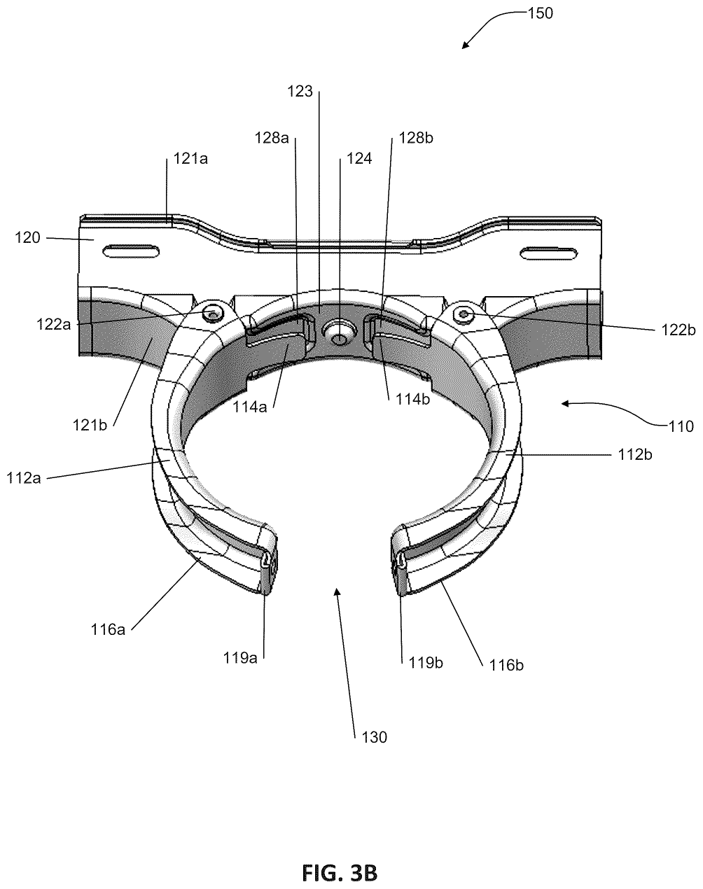

FIG. 2A is a front view of a coupling system or fastening assembly 150 coupled to the torque tube 14 in accordance with the present disclosure, FIG. 2B is a bottom perspective view of the fastening assembly 150, with the torque tube 14 removed. FIG. 3A is a front view of the fastening assembly 150 in a slightly open position, and FIG. 3B is a bottom perspective view of the fastening assembly 150, with the torque tube 14 removed. FIGS. 2A to 3B illustrate a first side 151 of the fastening assembly 150. While a second side of the fastening assembly is not explicitly shown, it will be appreciated that the second side is a mirror image of the first side 151. The fastening assembly 150 may include a support rail 120 and a strap assembly 110. The fastening assembly 150 may be used with a solar tracker, e.g., solar tracker 10 in FIG. 1. The support rail 120 may be configured to be secured to the torque tube 14 via the strap assembly 110. In this manner, the strap assembly 110 is operatively coupled to the support rail 120 and is configured to be clamped or secured to the torque tube 14 via one or more rigid arms, as described further herein. In some embodiments, the solar tracker 10 may include multiple fastening assemblies 150 positioned along the torque tube 14 configured to secure multiple solar modules 12 to the torque tube 14.

The strap assembly 110 may be operatively coupled to the support rail 120 via one or more rigid arms. In this example, the one or more rigid arms may include a first rigid arm 112a and a second rigid arm 112b. The first rigid arm 112a may include an upper portion 114a and a lower portion 116a with a respective rotational axis being therebetween. The second rigid arm 112b may include an upper portion 114b and a lower portion 116b with a respective rotational axis being therebetween. The first rigid arm 112a and the second rigid arm 112b may each be pivotably connected to the support rail 120 via a connector, such as, for example a first pin 122a and a second pin 122b, respectively. The first pin 122a may be configured to extend through a first proximal ridge 123a of the first rigid arm 112a, through the support rail 120, and through a second proximal ridge on the second side of the fastening assembly 150 (not explicitly shown) of the first rigid arm 112a, thereby securing the first rigid arm 112a to the support rail 120 and providing pivoting about a central axis of the first pin 122a. The second pin 122b may be configured to extend through a third proximal ridge 125a of the second rigid arm 112b, through the support rail 120, and through a fourth proximal ridge on the second side of the fastening assembly (not explicitly shown) of the second rigid arm 112b, thereby securing the second rigid arm 112b to the support rail 120 and providing pivoting about a central axis of the second pin 122b. While it is shown that the first rigid arm 112a is coupled to the support rail 120 via the first pin 122a and the second rigid arm 112b is coupled to the support rail 120 via the second pin 122b, it may be contemplated that the first rigid arm 112a and the second rigid arm 112b may be coupled to the support rail 120 via any other connector that allows for a pivotable connection, such as, for example, a swivel joint connector, a slip ring connector, or any other suitable connector as desired.

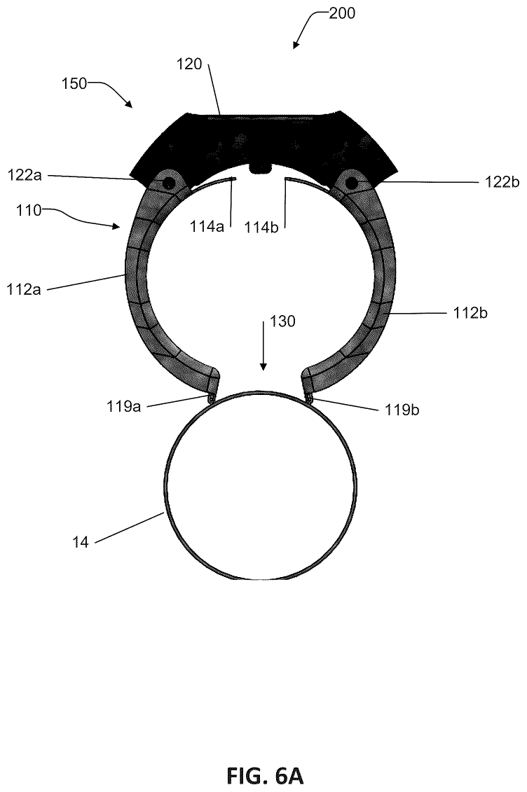

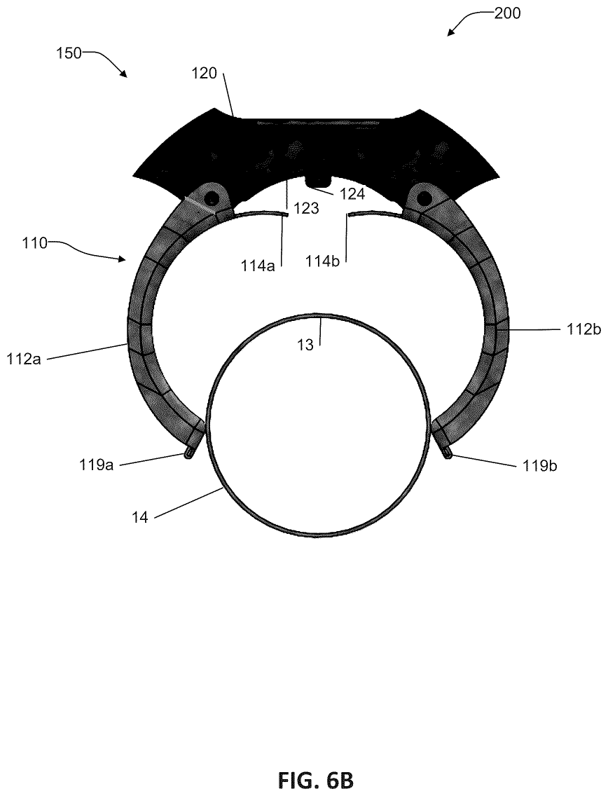

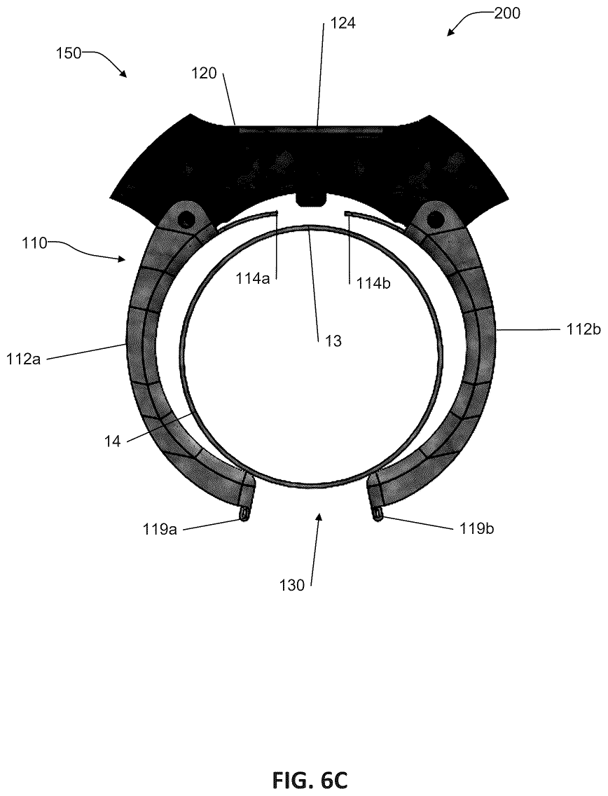

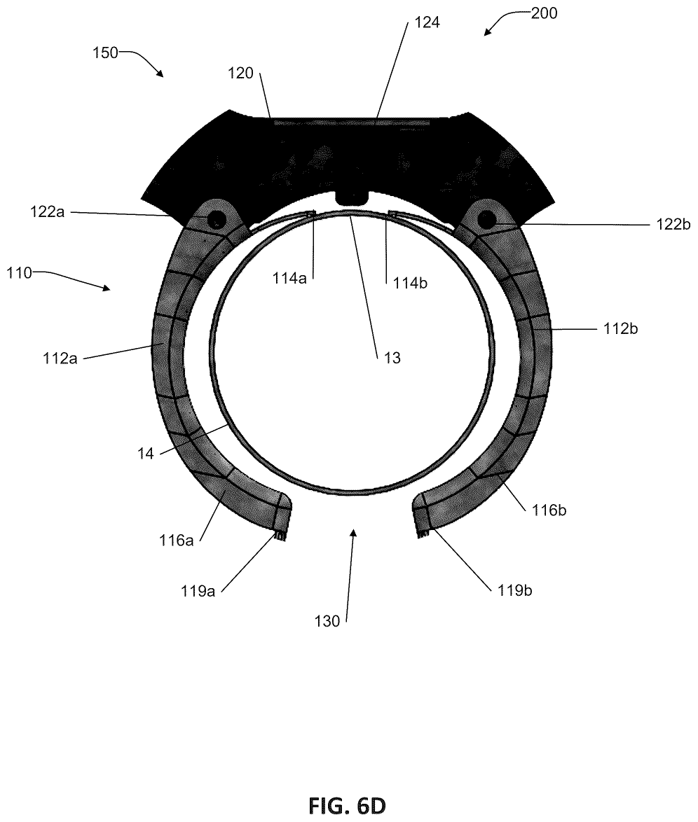

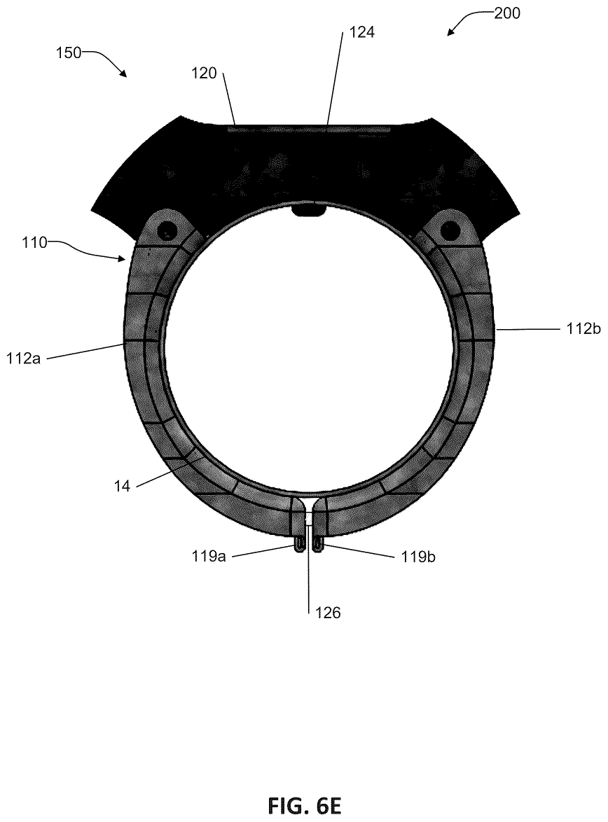

The upper portions 114a, 114b may extend from the first pin 122a and the second pin 122b, respectively, towards a torque tube receiving surface 123 of the support rail 120, as shown more clearly in FIG. 2B. The upper portions 114a, 114b may be configured to engage with one or more recesses within the torque tube receiving surface 123 of the support rail 120. The one or more recesses may include, for example, a first recess 128a configured to receive the upper portion 114a, and a second recess 128b configured to receive the upper portion 114b. In some examples, the upper portions 114a, 114b may be pushed into the first recess 128a and the second recess 128b, respectively, by the torque tube 14 when the torque tube receiving surface 123 is moved towards the torque tube 14, as shown further with reference to FIGS. 6A to 6E. In some examples, pivotable connections, such as the first pin 122a and the second pin 122b, may move the upper portions 114a, 114b towards the torque tube receiving surface 123 when the first rigid arm 112a and the second rigid arm 112b are pivoted towards the closed position. The upper portions 114a, 114b and the one or more recesses 128a, 128b cooperate such that the upper portions 114a, 114b are flush with, or recessed, from the torque tube receiving surface 123, and the torque tube receiving surface 123 may engage the torque tube 14, when the first rigid arm 112a and the second rigid arm 112b are pivoted to a closed position, as shown in FIGS. 2A and 2B.

The upper portions 114a, 114b may each be configured as a counterweight to the distal ends 119a, 119b, respectively. The counterweight function of the upper portions 114a, 114b provides stability and balance to the first rigid arm 112a and the second rigid arm 112b, respectively, and biases the first rigid arm 112a and the second arm 112b towards the neutral position, as shown in FIGS. 3A and 3B. When the torque tube 14 is positioned within the gap 130 and the torque tube receiving surface 123 of the support rail 120 is moved towards the torque tube 14, the torque tube 14 engages the upper portions 114a, 114b, and pushes them into the one or more recesses 128a 128b, thereby causing the first rigid arm 112a and the second arm 112b to pivot towards the closed position, moving distal ends 119a, 119b of the first rigid arm 112a and the second arm 112b, together such that the distal ends 119a, 119b can be fastened together via the connector 126.

The lower portions 116a, 116b may extend from the bottom, or torque tube receiving surface 121b, and may be configured to extend at least partially around the torque tube 14. The lower portions 116a, 116b may each include a distal end 119a, 119b, respectively. The distal ends 119a, 119b may be fastened together via a connector 126 when the first rigid arm 112a and the second arm 112b are pivoted to the closed position, as shown in FIGS. 2A and 2B. The connector may include, for example, a bolt, a screw clamp, or connectors formed on the distal ends 119a, 119b. The first rigid arm 112a and the second rigid arm 112b along with the first pin 122a and the second pin 122b may cooperate such that the first rigid arm 112a and the second rigid arm 112b may pivot to a neutral position, as shown in FIGS. 3A to 3B, under the force of gravity and the distal ends 119a, 119b may form a gap 130 (FIG. 3A) therebetween wide enough to permit a portion of the torque tube 14 to pass therethrough. The gap 130 formed when the first rigid arm 112a and the second rigid arm 112b are pivoted to the neutral position is sufficiently wide that the gap 130 will widen when the torque tube receiving surface 123 is moved towards the torque tube 14.

As shown in FIGS. 2B and 3B, the first rigid arm 112a may include one or more ribs, such as a first rib 118a and a second rib 118b, and the second rigid arm 112b may further include one or more ribs, such as a third rib 118c and a fourth rib 118d. The one or more ribs 118a, 118b, 118c, 118d (generally referred to herein as one or more ribs 118) may be configured to add rigidity to the first rigid arm 112a and the second rigid arm 112b by creating a non-flat cross-section to the first rigid arm 112a and the second rigid arm 112b. In some embodiments, the strap assembly 110 may include a generally circular profile so as to form a tight fit around the torque tube 14. In some embodiments, the strap assembly 110 and/or the torque tube 14 may include a square profile, an oval profile, a hexagonal profile, or any other suitable profile, and the strap assembly 110 and torque tube 14 may have the same or different profile. In some embodiments, the strap assembly 110 may be formed from steel, aluminum, titanium, titanium alloys, composite materials, or the like.

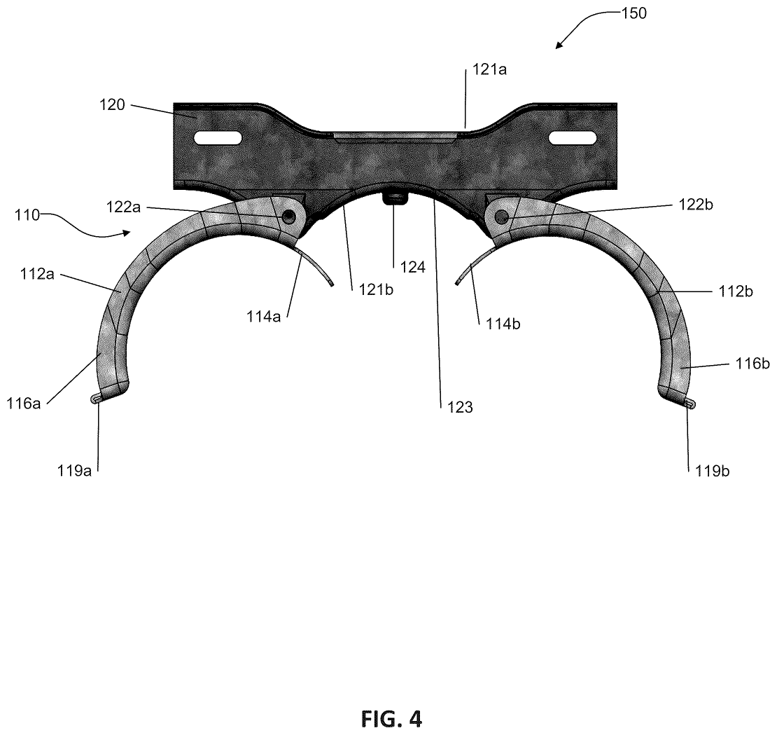

FIG. 4 is a front view showing the first side 151 of the fastening assembly 150 in a fully open position, with the torque tube 14 removed. As shown in FIG. 4, the first rigid arm 112a and the second arm 112b are pivotable to an open position where the gap 130 between the distal ends 119a, 119b of the lower portions 116a, 116b is wide enough to pass the entire torque tube 14 therethrough. In some examples, a gap width of the open position being wider than a gap width of the neutral position, as shown in FIGS. 6A to 6E.

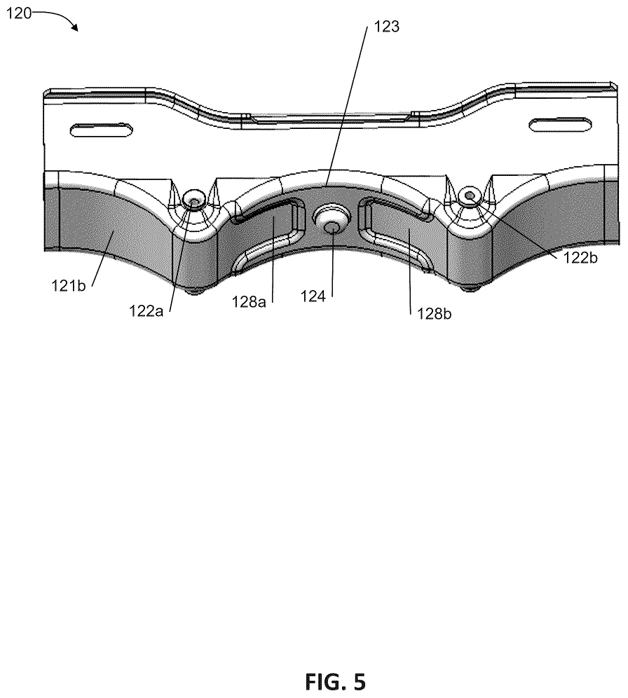

FIG. 5 is a bottom perspective view of the support rail 120 of the fastening assembly 150. The support rail 120 may define opposed top 121a and bottom 121b surfaces. The top surface 121a may be configured to support a portion of a solar module (e.g., solar module 12), and the bottom surface 121b may include a saddle shape that defines the torque tube receiving surface 123 configured to interface with the torque tube 14. Further, the support rail 120 may include a bump 124 that may be configured to be inserted into a hole or a bore 13, as shown in FIG. 3A, on the torque tube 14. The bump 124 may be located between the upper portions 114a, 114b of the first rigid arm 112a and the second arm 112b when the first rigid arm 112a and the second arm 112b are pivoted to the closed position. The engagement of the bump 124 with the bore 13 serves to hold the support rail 120 relative to the torque tube 14 to prevent or restrict inadvertent movement of the support rail 120 relative to the torque tube 14. In other words, the support rail 120 will rotate with the torque tube 14 when the torque tube 14 moves, but the support rail 120 will not move independent of the torque tube 14. In some examples, the support rail 120 may not include the bump 124 and the support rail 120 may be secured to the torque tube 14 via frictional engagement between the strap assembly 110 and the torque tube 14 when the lower portions 116a, 116b are fastened together, as shown in FIGS. 2A and 2B. In such examples, the frictional engagement between the strap assembly 110 and the torque tube 14 will cause the support rail 120 to rotate with the torque tube 14 when the torque tube 14 moves, but the support rail 120 will not move independent of the torque tube 14.

As previously discussed, the torque tube receiving surface 123 may include the one or more recesses 128a, 128b. The one or more recesses 128a, 128b may include a size and shape configured to receive the upper portions 114a, 114b, respectively. The one or more recesses 128a, 128b may include a depth that matches a thickness of the upper portions 114a, 114b such that when the fastening assembly 150 is in the closed position (FIG. 2A), the upper portions 114a, 114b are flush within the one or more recesses 128a, 128b so that the torque tube 14 engages with the torque tube receiving surface 123 of the support rail 120 when the fastening assembly 150 is in the closed position.

FIGS. 6A to 6E illustrate a method 200 of use for the coupling system or fastening assembly 150, as in FIGS. 2A to 5. As shown in FIG. 6A, the gap 130 between the distal ends 119a, 119b of the first rigid arm 112a and the second arm 112b is positioned adjacent the torque tube 14. The first rigid arm 112a and the second rigid arm 112b along with the first pin 122a and the second pin 122b may cooperate such that the first rigid arm 112a and the second rigid arm 112b may pivot to a neutral position, as shown in FIG. 6A, under the force of gravity and the distal ends 119a, 119b may form the gap 130 therebetween. The gap 130 formed when the first rigid arm 112a and the second rigid arm 112b are pivoted to the neutral position is sufficiently wide that the gap 130 will widen when the torque tube receiving surface 123 is moved towards the torque tube 14, as shown in FIG. 6B.

As shown in FIGS. 6C and 6D, moving the torque tube receiving surface 123 towards the torque tube 14, thereby widens the gap 130 to permit the entire torque tube 14 to pass therethrough. When the torque tube 14 is positioned within the gap 130 and the torque tube receiving surface 123 of the support rail 120 is moved towards the torque tube 14, the torque tube 14 engages the upper portions 114a, 114b, and pushes them into the one or more recesses 128a 128b, thereby causing the first rigid arm 112a and the second arm 112b to pivot towards the closed position, moving distal ends 119a, 119b of the first rigid arm 112a and the second arm 112b, together such that the distal ends 119a, 119b can be fastened together via the connector 126. Moving the first rigid arm 112a and the second arm 112b to a closed position may position the bump 124 such that bump 124 may be configured to be inserted into a hole or a bore 13 on the torque tube 14. The bump 124 may be located between the upper portions 114a, 114b of the first rigid arm 112a and the second arm 112b when the first rigid arm 112a and the second arm 112b are pivoted to the closed position. The engagement of the bump 124 with the bore 13 serves to hold the support rail 120 relative to the torque tube 14 to prevent or restrict inadvertent movement of the support rail 120 relative to the torque tube 14. In other examples, moving the first rigid arm 112a and the second arm 112b to a closed position may create a frictional engagement between the first rigid arm 112a and the second arm 112b and the torque tube resist rotation of the torque tube relative to the first rigid arm 112a and the second arm 112b.

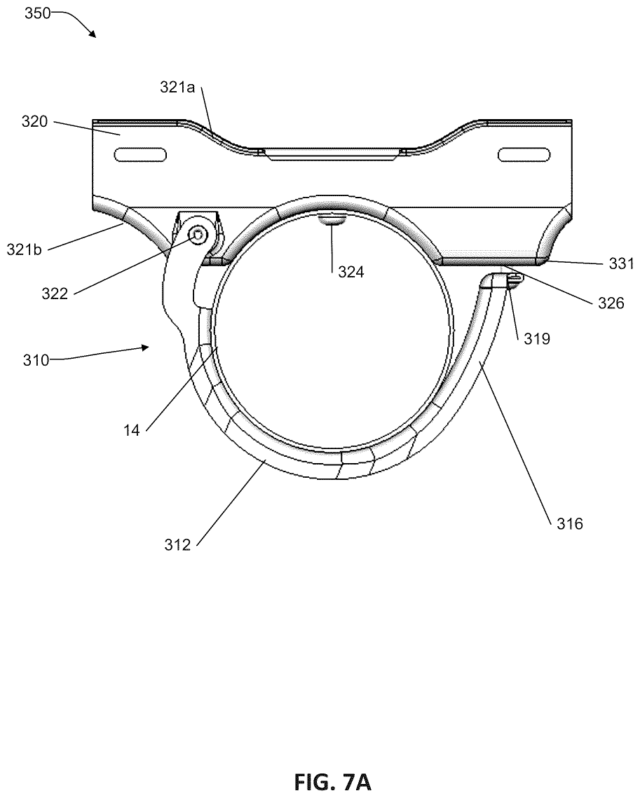

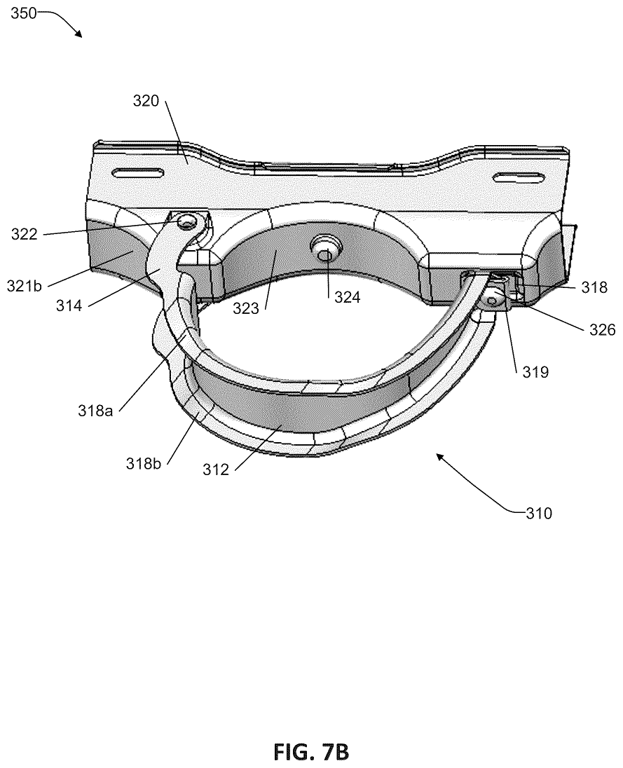

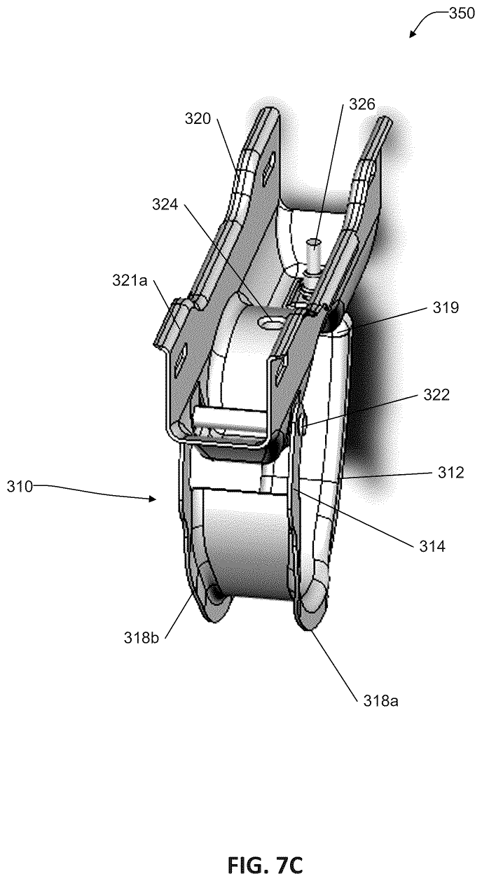

FIG. 7A is a front view of a coupling system or a fastening assembly 350 in accordance with the present disclosure, FIG. 7B is a is a bottom perspective view of the fastening assembly 350 with the torque tube 14 removed, and FIG. 7C is a top perspective view of the fastening assembly 350 with the torque tube 14 removed. FIGS. 7A to 7C illustrate a first side 351 of the fastening assembly 350. While a second side of the fastening assembly is not explicitly shown, it will be appreciated that the second side is a mirror image of the first side 351. The fastening assembly 350 is like the fastening assembly 150 except that the fastening assembly 350 includes one rigid arm 312.

The fastening assembly 350 may include a support rail 320 and a strap assembly 310. The fastening assembly 350 may be used with a solar tracker, e.g., solar tracker 10 in FIG. 1. The support rail 320 may be configured to be secured to the torque tube 14 via the strap assembly 310. In this manner, the strap assembly 310 is operatively coupled to the support rail 320 and is configured to be clamped or secured to the torque tube 14 via one or more rigid arms, as described further herein. In some embodiments, the solar tracker 10 may include multiple fastening assemblies 350 positioned along the torque tube 14 configured to secure multiple solar modules 12 to the torque tube 14.

The strap assembly 310 may be operatively coupled to the support rail 320 via one or more rigid arms. In this example, the one or more rigid arms may include one rigid arm 312 configured to couple the support rail 320 to the torque tube 14. The one rigid arm 312 may be pivotably connected to the support rail 320 via a connector, such as, for example a pin 322. The pin 322 may be configured to extend through a first proximal ridge 323a of the one rigid arm 312, through the support rail 320, and through a second proximal ridge on the second side of the fastening assembly 350 (not explicitly shown) of the one rigid arm 312, thereby securing the one rigid arm 312 to the support rail 320 and providing pivoting about a rotational axis of the pin 322. While it is shown that the one rigid arm 312 is coupled to the support rail 320 via the pin 322, it may be contemplated that the one rigid arm 312 may be coupled to the support rail 320 via any other connector that allows for a pivotable connection, such as, for example, a swivel joint connector, a slip ring connector, or any other suitable connector as desired.

In some examples, the one rigid arm 312 may include a lower portion 316 configured to extend around the torque tube 14. The lower portion 316 may further include a distal end 319 configured to be fastenable to the support rail 320 at a rail connection point 318 via a connector 326 when the one rigid arm 312 is pivoted to a closed position. In some examples, the connector 326 may include a bolt, a screw clamp, or one or more connectors formed on the distal end 319 of the one rigid arm 312. In some examples, the one rigid arm 312 and the pivotal connection (e.g., the pin 322) may cooperate such that the one rigid arm 312 pivots to a neutral position under the force of gravity. In such cases, the distal end 319 forms a gap 330 with the rail connection point 318, while in the neutral position, wide enough to permit a portion of the torque tube 14 to pass therethrough. The gap 330 formed when the one rigid arm 312 is pivoted to the neutral position is sufficiently wide that the gap 330 will widen when the distal end 319 and the rail connection point 318 are moved towards the torque tube 14. Further, the one rigid arm 312 may be pivotable to an open position where the gap 330 between the distal end 319 and rail connection point 318 is wide enough to pass the entire torque tube 14 therethrough, such that a gap width of the open position being wider than a gap width of the neutral position.

The support rail 320 may define opposed top 321a and bottom 321b surfaces. The top surface 321a may be configured to support a portion of a solar module (e.g., solar module 12), and the bottom surface 321b may include a saddle shape that defines the torque tube receiving surface 323 configured to interface with the torque tube 14. Further, the support rail 320 may include a bump 324 that may be configured to be inserted into a hole or a bore 13, as shown in FIG. 7A, on the torque tube 14. The engagement of the bump 324 with the bore 13 serves to hold the support rail 320 relative to the torque tube 14 to prevent or restrict inadvertent movement of the support rail 320 relative to the torque tube 14. In other words, the support rail 320 will rotate with the torque tube 14 when the torque tube 14 moves, but the support rail 320 will not move independent of the torque tube 14. In some examples, the support rail 320 may not include the bump 324 and the support rail 320 may be secured to the torque tube 14 via frictional engagement between the strap assembly 310 and the torque tube 14 when the distal end 319 is fastened to the support rail 320 at a rail connection point 318, as shown in FIGS. 7A to 7C. In such examples, the frictional engagement between the strap assembly 310 and the torque tube 14 will cause the support rail 320 to rotate with the torque tube 14 when the torque tube 14 moves, but the support rail 320 will not move independent of the torque tube 14.

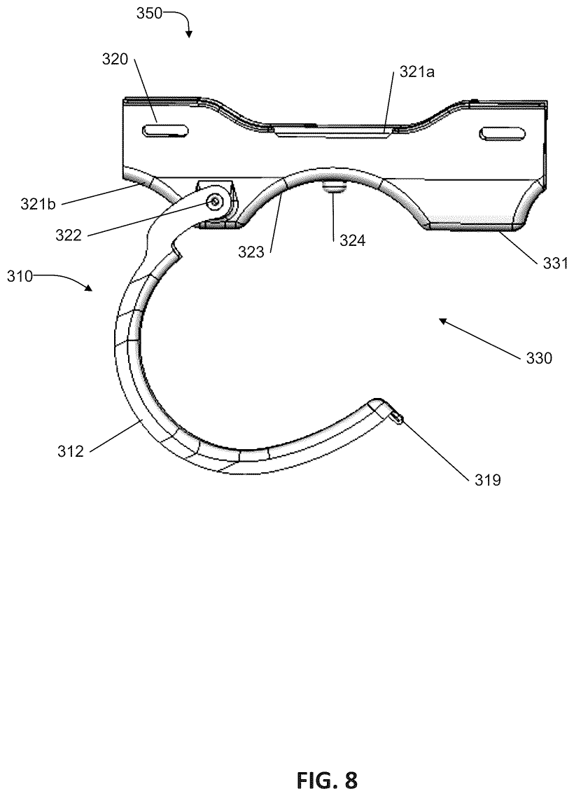

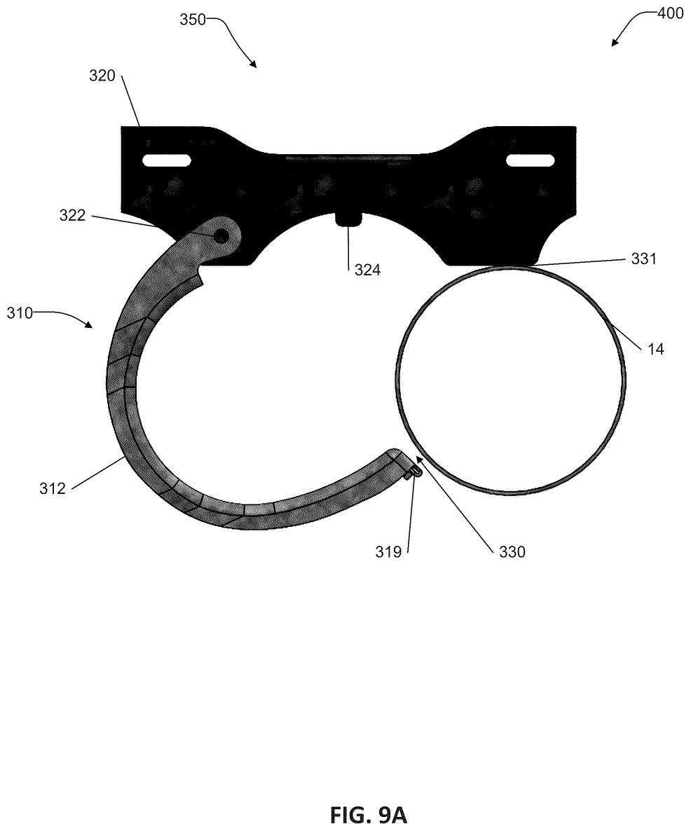

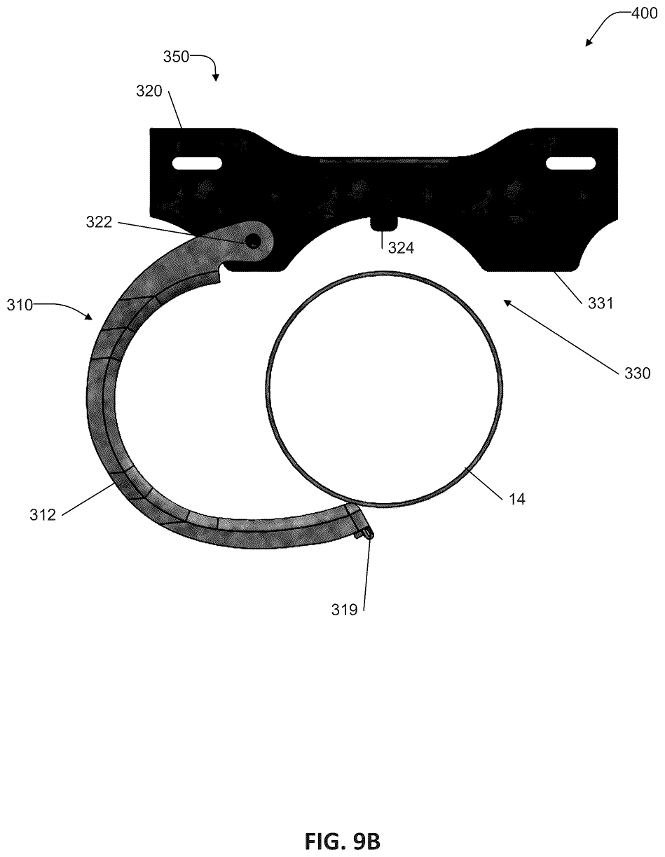

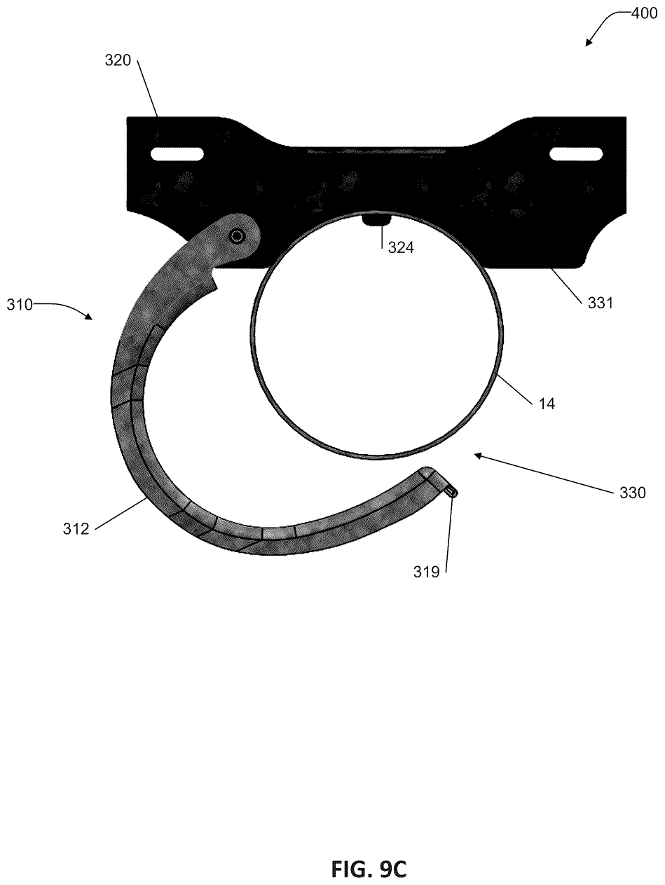

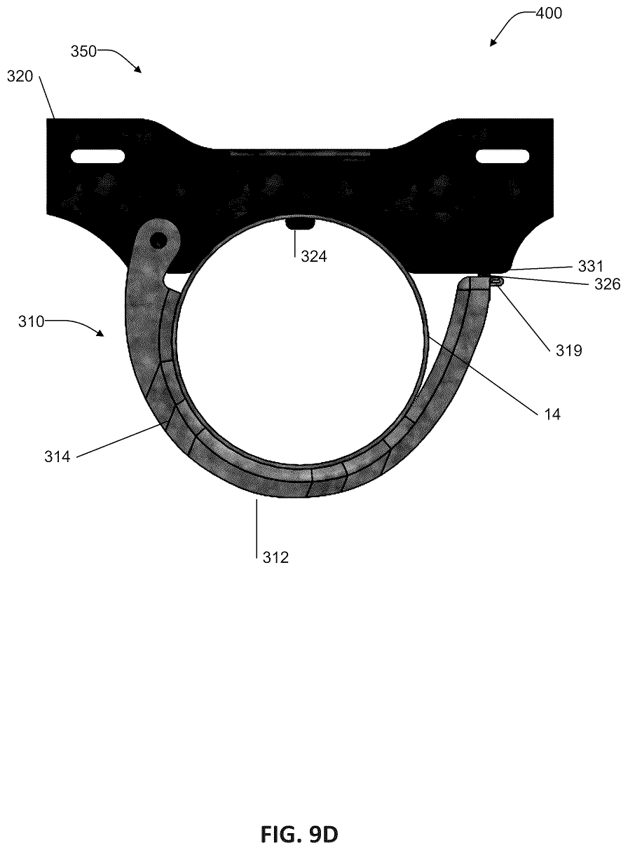

FIG. 8 is a front view of the first side of the fastening assembly 350 with the one rigid arm 312 in an open position and the torque tube 14 removed. As shown in FIG. 8, the one rigid arm 312 is pivotable to an open position where the gap 330 between the distal end 319 of the lower portion 316 and the rail connection point 318 is wide enough to pass the entire torque tube 14 therethrough. In some examples, a gap width of the open position being wider than a gap width of the neutral position, as shown in FIGS. 9A to 9D.

FIGS. 9A to 9D illustrate a method 400 of use for the fastening assembly 350, as in FIGS. 7A to 8. As shown in FIG. 9A, the gap 330 between the distal end 319 of the rail connection point 318 is positioned adjacent the torque tube 14. The one rigid arm 312 along with the pin 322 may cooperate such that the one rigid arm 312 may pivot to a neutral position, as shown in FIG. 9A, under the force of gravity and the distal end 319 and the rail connection point 318 may form the gap 330 therebetween. The gap 330 formed when the one rigid arm 312 is pivoted to the neutral position is sufficiently wide that the gap 330 will widen when the torque tube receiving surface 323 is moved towards the torque tube 14, as shown in FIGS. 9B to 9C.

As shown in FIGS. 9B and 9C, moving the torque tube receiving surface 323 towards the torque tube 14, thereby widens the gap 330 to permit the entire torque tube 14 to pass therethrough. When the torque tube 14 is positioned within the gap 330 and the torque tube receiving surface 323 of the support rail 320 is moved towards the torque tube 14, the torque tube 14 engages the bump 324 such that bump 324 may be configured to be inserted into a hole or a bore 13 on the torque tube 14. The engagement of the bump 324 with the bore 13 serves to hold the support rail 320 relative to the torque tube 14 to prevent or restrict inadvertent movement of the support rail 320 relative to the torque tube 14. In other examples, moving the one rigid arm 312 to a closed position may create a frictional engagement between the one rigid arm 312 and the torque tube 14, thereby resisting rotation of the torque tube 14 relative to the one rigid arm 312.

When the torque tube 14 is positioned completely within the gap 330, the one rigid arm 312 may be configured to close around the torque tube 14 and coupled to the rail connection point 318 via a connector 326 (e.g., a bolt, screw clamp, or connectors formed on the distal end 319 and the rail connection point 318), thereby securing the support rail 320 to the torque tube 14.

Various non-limiting exemplary embodiments have been described. It will be appreciated that suitable alternatives are possible without departing from the scope of the examples described herein.

1. A coupling system for use with a solar tracker, comprising:
a support rail defining opposed top and bottom surfaces, the top surface configured to support a portion of a solar module, the bottom surface defining a saddle shape that includes a torque tube receiving surface configured to interface with a torque tube;
two rigid arms configured to couple the support rail to the torque tube, each rigid arm pivotably connected to the support rail and being pivotable about a rotational axis, the two rigid arms pivotable into a closed position, each rigid arm having upper and lower portions with the respective rotational axis being therebetween, the lower portion extending from the bottom surface of the support rail and configured to extend at least partially around a torque tube, the upper portion extending towards the torque tube receiving surface;
the pivotable connections moving the upper portions towards the torque tube receiving surface when the two rigid arms are pivoted towards the closed position, the upper portions configured to be pushed towards the torque tube receiving surface as when the two rigid arms are pivoted towards the closed position.

2. The coupling system of claim 1, wherein the torque tube receiving surface has one or more recesses for receiving the upper portions of the two rigid arms when the two rigid arms are pivoted to the closed position.

3. The coupling system of claim 2, wherein the upper portions and the one or more recesses cooperate such that the upper portions are flush with or recessed from the torque tube receiving surface when the two rigid arms are pivoted to the closed position.

4. The coupling system of claim 3, wherein the torque tube receiving surface engages the torque tube when the two rigid arms are pivoted to the closed position.

5. The coupling system of claim 3, wherein the upper portions are pushed into the one or more recesses by a torque tube when the torque tube receiving surface is moved towards the torque tube.

6. The coupling system of claim 1, wherein the two rigid arms are pivoted towards the closed position when the torque tube receiving surface is moved towards the torque tube.

7. The coupling system of claim 1, wherein the lower portions have distal ends, the two rigid arms and the pivotal connections cooperating such that the two rigid arms pivot to a neutral position under the force of gravity, the distal ends in the neutral position forming a gap therebetween wide enough to permit a portion of a torque tube to pass therethrough.

8. The coupling system of claim 7, wherein the gap formed when the two rigid arms are pivoted to the neutral position is sufficiently wide that the gap will widen when the torque tube receiving surface is moved towards the torque tube.

9. The coupling system of claim 7, wherein the two rigid arms are pivotable to an open position where the gap between the distal ends of the lower portions is wide enough to pass the entire torque tube therethrough, the gap width of the open position being wider than the gap width of the neutral position.

10. The coupling system of claim 1, further comprising a bump extending from the torque tube receiving surface that is configured for insertion into a hole in the torque tube to restrict relative movement between the support rail and the torque tube, the bump being located between the upper portions of the rigid arms when the arms are pivoted to the closed position.

11. The coupling system of claim 1, wherein the lower portions have distal ends fastenable together via a connector, such as a bolt, screw clamp, or via connectors formed on the distal ends, when the two rigid arms are pivoted to the closed position, the two rigid arms resisting rotation of the torque tube relative to the two rigid arms via frictional engagement between the two rigid arms and the torque tube when the lower portions are fastened together.

12. The coupling system of claim 1, wherein the two rigid arms include one or more ribs to add rigidity or have a non-flat cross-section to add rigidity.

13. The coupling system of claim 1, wherein the pivotal connection between each of the two rigid arms and the support rail is via pin that extends therethrough providing pivoting about the central axis of the pin.

14. A coupling system for use with a solar tracker, comprising:
a support rail defining opposed top and bottom surfaces, the top surface configured to support a portion of a solar module, the bottom surface defining a saddle shape that includes a torque tube receiving surface configured to interface with a torque tube;
one rigid arm configured to couple the support rail to the torque tube, the one rigid arm pivotably connected to the support rail and being pivotable about a rotational axis, the one rigid arm having a lower portion extending from a pivotal connection and from the bottom surface of the support rail and configured to extend around a torque tube;
the one rigid arm having a distal end fastenable to the support rail at a rail connection point via a connector, such as a bolt, screw clamp, or via connectors formed on the distal ends, when the one rigid arm is pivoted to a closed position, the one rigid arm and the pivotal connection cooperating such that the one rigid arm pivots to a neutral position under the force of gravity, the distal end in the neutral position forming a gap with the rail connection point wide enough to permit a portion of a torque tube to pass therethrough, the gap formed when the one rigid arm is pivoted to the neutral position is sufficiently wide that the gap will widen when the distal end and the rail connection point are moved towards the torque tube.

15. The coupling system of claim 14, wherein the one rigid arm is pivotable to an open position where the gap between the distal end and rail connection point is wide enough to pass the entire torque tube therethrough, the gap width of the open position being wider than the gap width of the neutral position.

16. A method of using a coupling system to couple a rail to a torque tube, the method comprising:
positioning a coupling system adjacent a torque tube, the coupling system comprising:
a support rail defining opposed top and bottom surfaces, the top surface configured to support a portion of a solar module, the bottom surface defining a saddle shape that includes a torque tube receiving surface configured to interface with a torque tube; and
one or more rigid arms configured to couple the support rail to the torque tube, the one or more rigid arms pivotably connected to the support rail and being pivotable about a rotational axis;
wherein when the one or more rigid arms are in a neutral position, a gap is formed that is sufficiently wide enough to permit a portion of the torque tube to pass therethrough;
moving the torque tube receiving surface towards the torque tube, thereby widening the gap to permit the entire torque tube to pass therethrough; and
moving the one or more rigid arms to a closed position thereby creating a frictional engagement between the one or more rigid arms and the torque tube to resist rotation of the torque tube relative to the one or more rigid arms.

17. The method of claim 16, wherein the one or more rigid arms comprises two rigid arms configured to couple the support rail to the torque tube, each rigid arm pivotably connected to the support rail and being pivotable about a rotational axis, the two rigid arms pivotable into a closed position, each rigid arm having upper and lower portions with the respective rotational axis being therebetween, the lower portion extending from the bottom surface of the support rail and configured to extend at least partially around a torque tube, the upper portion extending towards the torque tube receiving surface.

18. The method of claim 17, wherein the torque tube receiving surface has one or more recesses for receiving the upper portions of the two rigid arms when the two rigid arms are pivoted to the closed position, and the upper portions and the one or more recesses cooperate such that the upper portions are flush with or recessed from the torque tube receiving surface when the two rigid arms are pivoted to the closed position.

19. The method of claim 16, wherein the one or more rigid arms comprises one rigid arm configured to couple the support rail to the torque tube, the one rigid arm pivotably connected to the support rail and being pivotable about a rotational axis, the one rigid the lower portion extending from pivotal connection and from the bottom surface of the support rail and configured to extend around a torque tube.

20. The method of claim 19, wherein the one rigid arm is pivotable to an open position where the gap between a distal end and a rail connection point is wide enough to pass the entire torque tube therethrough, a gap width of the open position being wider than a gap width of the neutral position.
